(19) United States
(12) Patent Application Publication
(10) Pub. No.: US 2026/0161313 A1
(43) Pub. Date: Jun. 11, 2026

(54) DATA PROCESSING SYSTEMS

(71) Applicant: Arm Limited, Cambridge (GB)

(72) Inventors: Brian Paul Starkey, Cambridge (GB); Damian Piotr Modrzyk, Katowice (PL); Mark Underwood, Cambridge (GB)

(73) Assignee: Arm Limited, Cambridge (GB)

(21) Appl. No.: 18/970,149

(22) Filed: Dec. 5, 2024

(51) Int. Cl. G06F 3/06

(52) U.S. Cl. CPC G06F 3/064; G06F 3/0608

(57) ABSTRACT

A data processing system is disclosed that includes a data processing unit and a codec unit. A set of addresses of an address space is associated with the codec unit, and the codec unit, in response to a request from the data processing unit to access an address of the set of addresses associated with the codec unit, provides decoded data to the data processing unit or causes data provided by the data processing unit to be encoded.

### BACKGROUND

The technology described herein relates to data processing systems, and in particular to compression and decompression of data (data arrays) in data processing systems, such as graphics processing systems.

A data processing unit, such as a central processing unit (CPU) or graphics processing unit (GPU), typically performs processing operations by processing data in an uncompressed form. Output data produced by such operations may be written to memory for storage before further processing by a data processing unit.

To reduce the amount of data that needs to be transferred to and from memory, and the associated power cost of moving such data back and forth, the data may be compressed before being written to memory. This allows the data to be stored in a compressed format. Then, when a data processing unit requires the data for further processing, the compressed data is read from memory and decompressed, such that it is then in a suitable format for processing by the data processing unit.

The Applicants believe that there remains scope for improvements to data compression and decompression arrangements in data processing systems.

### BRIEF DESCRIPTION OF THE DRAWINGS

Embodiments of the technology described herein will now be described by way of example only and with reference to the accompanying drawings, in which:

FIG. 1 shows an exemplary data processing system;

FIG. 2 shows a data processing system in accordance with embodiments of the technology described herein;

FIG. 3 shows a codec unit in accordance with embodiments of the technology described herein;

FIG. 4 shows a codec unit in accordance with embodiments of the technology described herein;

FIG. 5 shows a process for setting up a codec unit in accordance with embodiments of the technology described herein;

FIG. 6, FIG. 7 and FIG. 8 show a process for triggering a codec unit to compress or decompress data in accordance with embodiments of the technology described herein; and

FIG. 9 shows a process for resetting a codec unit in accordance with embodiments of the technology described herein.

Like reference numerals are used for like components where appropriate in the drawings.

### DETAILED DESCRIPTION

A first embodiment of the technology described herein comprises a method of operating a data processing system that comprises:
a data processing unit; and
a codec unit configured to encode and decode data;
the method comprising:
associating a set of addresses of an address space with the codec unit; and
the codec unit, in response to a request from the data processing unit to access an address of the set of addresses associated with the codec unit:
   providing decoded data to the data processing unit or causing data provided by the data processing unit to be encoded.

A second embodiment of the technology described herein comprises a data processing system comprising:
a data processing unit; and
a codec unit configured to encode and decode data;
wherein the data processing system is configured to associate a set of addresses of an address space with the codec unit; and
the codec unit is configured to, in response to a request from the data processing unit to access an address of a set of addresses associated with the codec unit:
   provide decoded data to the data processing unit or cause data provided by the data processing unit to be encoded.

The technology described herein relates to a data processing system, such as a graphics processing system, that includes at least one data processing unit, such as a central processing unit (CPU) and/or a graphics processing unit (GPU). The system should, and in embodiments does, include a memory system that the (at least one) data processing unit can access (read from and/or write to), e.g. by issuing an appropriate request to access an address of an address space associated with (e.g. mapped to) the memory system, e.g. in the normal manner for the data processing system in question.

The system further includes a (compression) codec unit that is operable to encode and decode (e.g. compress and decompress) data for the (at least one) data processing unit, e.g. and in embodiments, such that the data processing unit can “offload” encoding and decoding (compression and decompression) operations to the codec unit.

In embodiments of the technology described herein, in order for the data processing unit to be able to trigger the (compression) codec unit to perform its desired encoding and/or decoding (compression and/or decompression) operations, a set of addresses of an address space that the data processing unit can issue access requests to is associated with (e.g. mapped to) the codec unit, and the codec unit is configured to perform encoding and/or decoding (compression and/or decompression) operations in response to a request from the data processing unit to access an address of the set of addresses of the address space associated with (mapped to) the codec unit.

In embodiments, the addresses of the set of addresses associated with (mapped to) the codec unit are addresses of the same address space that is used to address the memory system. Thus, in embodiments the codec unit is “memory-mapped”.

The (at least one) data processing unit can thus, and in embodiments does, trigger the codec unit in essentially the same manner as it (directly) accesses the memory system.

As will be discussed in more detail below, this can allow compression and decompression operations to be “offloaded” to a (compression) codec unit in a particularly straightforward and efficient manner, e.g. without requiring (significant) modifications to the data processing unit. For example, the data processing unit may access compressed data without needing to know properties of the compression scheme used to compress the data. Software running on the data processing unit may thus access compressed data “transparently”. This can reduce implementation complexity/effort, overall hardware/silicon area costs and energy consumption associated with compression and decompression operations.

It will be appreciated, therefore, that the technology described herein provides an improved data processing system.

The data processing system should, and in embodiments does, comprise a memory system that the (at least one) data processing unit can access, e.g. read from and/or write to. The memory system should be, and in embodiments is, associated with a suitable address space, e.g. such that (at least a region of) the address space can be (and is) used to address (physical) storage elements of the memory system.

The memory system may comprise any suitable and desired memory for storing any suitable (e.g. compressed and/or uncompressed (not compressed)) data that the data processing system uses and/or produces, such as image data, texture data, graphics processing fragment or vertex data, video data, sound data, neural network data, etc. In embodiments, the system comprises (at least) a main (system) memory that is, in embodiments, an external memory, e.g. not on the same chip as the (at least one) data processing unit and/or the codec unit.

The memory system may (further) comprise a cache system (hierarchy), e.g. via which the (at least one) data processing unit can communicate with the (main) memory.

In embodiments, the system comprises a communications bus (interconnect) in communication with the (at least one) data processing unit and the memory system, and via which the data processing unit can access the memory system. The data processing unit may comprise a bus interface (bus adapter) that is in communication with the communications bus (interconnect), and via which the data processing unit can initiate bus transactions on the bus (interconnect), e.g. to access the memory system.

In embodiments, the (at least one) data processing unit can access the memory system by issuing a request to access a memory address that is associated with (e.g. mapped to) the (main) memory. The data processing unit may be able to use physical memory addresses to access the (main) memory. In embodiments, the data processing unit uses virtual memory addresses to access the (main) memory. The system may correspondingly comprise a memory management unit (MMU) that is operable to translate memory addresses appropriately, e.g. between virtual addresses used by the data processing unit and physical addresses used by the memory system.

The (at least one) data processing unit can be any suitable processor, such as (at least one of:) a central processing unit (CPU), a graphics processing unit (GPU) (graphics processor), a video processor, a sound processor, an image signal processor (ISP), a digital signal processor (DSP), a neutral network processor, a display controller, or another type of data processing unit. The data processing system may comprise two or more such data processing units that can communicate with each other (and the memory system) via the (system) communications bus (interconnect).

In embodiments, the data processing unit is a host processor, e.g. a central processing unit (CPU), of the data processing system. For example, the data processing system may be a graphics processing system that comprises a graphics processing unit (GPU) (graphics processor), and the data processing unit may be a host processor, e.g. a central processing unit (CPU), of the graphics processing system. In this case, the data processing unit (e.g. CPU) may execute applications that can require graphics processing by the graphics processor (GPU), and send appropriate commands and data to the graphics processor (GPU) to control it to perform graphics processing operations and to produce graphics processing (render) output required by applications executing on the host processor (e.g. CPU). To facilitate this, the (host processor) data processing unit (e.g. CPU) may also execute a driver for the graphics processor (GPU).

In embodiments, the (host processor) data processing unit (e.g. CPU) (also) executes a driver for the codec unit, and the system is set up and configured to operate in accordance with the technology described herein by the driver for the codec unit that is executing on the (host processor) data processing unit (e.g. CPU). Thus, in embodiments, a driver for the codec unit that is executing on the data processing unit (e.g. CPU) associates a set of addresses of an address space with the codec unit and configures the codec unit to provide decoded (decompressed) data to the data processing unit or cause data provided by the data processing unit to be encoded (compressed) in response to a request from the data processing unit to access an address of the set of addresses associated with the codec unit.

Thus, another embodiment comprises a method of operating a data processing system that comprises:
a (host processor) data processing unit; and
a codec unit configured to encode and decode data;
the method comprising (a driver for the codec unit that is executing on the (host processor) data processing unit):
associating a set of addresses of an address space with the codec unit; and
configuring the codec unit to provide decoded data to the data processing unit or cause data provided by the data processing unit to be encoded in response to a request from the data processing unit to access an address of the set of addresses associated with the codec unit.

Another embodiment comprises a data processing system that comprises:
a (host processor) data processing unit; and
a codec unit configured to encode and decode data;
wherein (a driver for the codec unit that is executing on the (host processor) data processing unit of) the data processing system is configured to:
associate a set of addresses of an address space with the codec unit; and
configure the codec unit to provide decoded data to the data processing unit or cause data provided by the data processing unit to be encoded in response to a request from the data processing unit to access an address of the set of addresses associated with the codec unit.

These embodiments can, and in embodiments do, include any one or more or all of the optional features described herein, as appropriate.

In embodiments, the (compression) codec unit is “memory-mapped”. That is, in embodiments, the addresses of the set of addresses associated with the codec unit are addresses of the same address space that is used (e.g. by the data processing unit) to address the memory system. Thus, in embodiments, at least a first region of an address space is associated with (mapped to) the (main) memory, and at least a second (non-overlapping) region of the same address space is associated with (mapped to) the codec unit (by the driver).

In embodiments, the (at least one) data processing unit can then (directly) access the (main) memory by issuing a request to access an address of the first address space region associated with the (main) memory, and can trigger the codec unit by issuing a request to access an address of the second address space region associated with the codec unit.

Thus, in embodiments, the (at least one) data processing unit can trigger the codec unit in substantially the same way as it triggers a direct access (e.g. read or write) to the memory system. The data processing unit may comprise an (bus) interface that can both access the memory system and trigger the codec unit to perform a data encoding and/or decoding (compression and/or decompression) operation for the data processing unit.

Where a data processing unit uses physical memory addresses to access the memory system, the data processing unit may also use physical addresses to trigger the codec unit. Where a data processing unit uses virtual memory addresses to access the memory system, the data processing unit may also use virtual addresses to trigger the codec unit (which virtual addresses may map to corresponding physical addresses). A set of physical addresses and/or a set of virtual addresses may thus be associated with the codec unit. Associating a set of addresses with the codec unit may comprise setting up any required address translations, e.g. that the memory management unit (MMU) may perform.

In embodiments, a set of addresses is associated with the codec unit (and the codec unit is correspondingly set up and configured) (by the driver) when (in response to) the data processing unit requires access to data that is stored in the memory system in encoded (compressed) form.

Encoded data that a data processing unit requires access to can take any suitable form. In embodiments, it is in the form of a data array, e.g. an image array (buffer), e.g. generated by a (the) graphics processing unit (GPU).

In embodiments, for each of one or more encoded (compressed) data arrays (e.g. image arrays) that the data processing unit requires access to, a respective set of addresses (of the same address space) is associated with the codec unit (by the driver). Thus, two or more different, e.g. non-overlapping, address space regions may be associated with the codec unit (by the driver), e.g. one for each encoded (compressed) data array (e.g. image array) that a data processing unit requires access to.

A set of addresses associated with the codec unit can take any suitable form. A set of addresses associated with the codec unit may comprise contiguous and/or non-contiguous memory addresses. In embodiments, a set of addresses associated with the codec unit is configured to address a decoded (decompressed) view of the corresponding encoded (compressed) data array, e.g. and in embodiments, such that the decoded (compressed) view of the encoded (compressed) data array appears to the data processing unit substantially (the same) as an unencoded (uncompressed) data array.

Thus, in embodiments, a (each) set of addresses associated with the codec unit can be (and is) used by the data processing unit to access a decoded (decompressed) view of the corresponding encoded (compressed) data array, e.g. as if it were accessing the data array in unencoded (uncompressed) form. In embodiments, the data processing unit can thus access an encoded (compressed) data array (via the codec unit) in substantially the same way as it accesses an unencoded (uncompressed) data array.

To facilitate this, in embodiments, when the data processing unit requires access to a data array that is stored in the memory system in encoded (compressed) form, a set of addresses is associated with the codec unit (by the driver) that has (essentially) the same configuration as (e.g. has as many addresses in it as) a set of addresses that would be used by the data processing unit to access the data array if the data array were stored in the memory system in unencoded (uncompressed) form. Thus, in embodiments, the system is configured to address an unencoded (uncompressed) data array using a set of addresses having a predefined format/layout, and the set of addresses associated with the codec unit has the (same) predefined format/layout (and addresses a decoded view of an encoded data array).

For example, and in embodiments, the data processing unit is configured to access a data element of a data array (e.g. image array) that is stored in unencoded (uncompressed) form by issuing a request that indicates a base memory address for the data array and an offset from the base memory address that indicates a position of the data element within the data array. In this case, in embodiments, a set of addresses associated with the codec unit is such that the data processing unit can access a decoded (decompressed) data element of a data array (e.g. image array) that is stored in encoded (compressed) form by issuing a request that indicates a base address for the data array that is in a set of addresses associated with the codec unit and an offset from the base address that indicates a position of the data element within the (unencoded) data array. Other arrangements are possible.

To do this, in embodiments, in response to a data processing unit requiring access to an encoded data array (buffer), one or more properties of an encoded (compressed) and/or decoded (decompressed) view of the data array are determined (by the driver), and a set of addresses for accessing the encoded data array (buffer) is allocated (by the driver) based on the determined one or more properties. The one or more properties may comprise any suitable properties, such as a size and/or format of the encoded (compressed) and/or decoded (decompressed) view of the data array.

The codec unit can be any suitable (system) component that is configured to encode and decode (compress and decompress) data for the (at least one) data processing unit. The codec unit should be, and in embodiments is, a separate unit to the (at least one) data processing unit, e.g. that is in communication with the (at least one) data processing unit via the (system) communications bus (interconnect). The codec unit may be external to (e.g. not on the same chip as) the (at least one) data processing unit. In embodiments, the codec unit is provided on the same chip as the (at least one) data processing unit.

In embodiments, to facilitate communication with the (at least one) data processing unit, the codec unit comprises a (subordinate) bus interface that is in communication with the (at least one) data processing unit via the communications bus (interconnect). In embodiments, a (the) set of addresses is associated with (mapped to) this (subordinate) bus interface (port) of the codec unit (by the driver).

In embodiments, the codec unit can (also) communicate with the memory system (via the (system) communications bus (interconnect)), e.g. to store encoded (compressed) data in the memory or to read encoded (compressed) data from the memory. In embodiments, to facilitate communication with the memory system, the codec unit (further) comprises a (manager) bus interface that is in communication with the memory system via the communications bus (interconnect). In embodiments, this (manager) bus interface of the codec unit can initiate bus transactions on the bus (interconnect) to access the memory system.

In embodiments, in response to the data processing unit requiring access to an encoded data array, as well as associating a suitable address space with the codec unit, the codec unit is set up and configured (by the driver) to encode and/or decode (compress and/or decompress) the data array appropriately. The codec unit may thus comprise one or more configurable components (that are set up and configured by the driver for the codec unit).

In embodiments, the codec unit comprises one or more configurable address converters that can be configured (by the driver) to convert an address of a set of addresses associated with the codec unit to a memory address associated with the memory, e.g. at which corresponding encoded (compressed) data array is (actually) stored. The one or more address converters may convert an address of a set of addresses associated with the codec unit into a physical memory address, or a virtual memory address (which may be translated to a physical memory address by a or the memory management unit (MMU)).

Corresponding, in embodiments, the (manager) bus interface of the codec unit is configured to fetch encoded (compressed) data from, or write encoded (compressed) data to, a memory address that has been converted appropriately by the one or more address converters.

In embodiments the codec unit comprises one or more configurable compression codecs that can be configured (by the driver) to compress and/or decompress data (of a data array), e.g. in accordance with a suitable encoding scheme (or schemes).

An encoding scheme may be any suitable lossless or lossy compression scheme. For example, the encoding scheme may comprise Adaptive Scalable Texture Compression (ASTC), e.g. as described in US 2012/0281007, the entire contents of which is hereby incorporated by reference, or Arm Frame Buffer Compression (AFBC), e.g. as described in US 2013/0036290 and US 2013/0198485, the entire contents of which is hereby incorporated by reference, or Arm Fixed Rate Compression (AFRC), e.g. as described in US 2021/0126736 and US 2022/0014767, the entire contents of which is hereby incorporated by reference. Other encoding schemes are possible.

In embodiments, the encoding (compression) scheme is block-based. Thus, in embodiments, an array of data (e.g. image array) is divided into a plurality of compression blocks, and encoded (compressed) data for each compression block is stored (in the memory). Encoded (compressed) data for each block may be stored (in the memory) at a respective memory address that can be determined based on the position within the array that the respective block represents (e.g. as described in US 2013/0036290). Other arrangements are possible.

Thus, in embodiments, in response to a data processing unit requiring access to an encoded data array (buffer), one or more properties of an encoded (compressed) and/or decoded (decompressed) view of the data array are determined (by the driver), and one or more configurable components of the codec unit (such as one or more configurable address converters and one or more configurable compression codecs) are configured appropriately (by the driver) based on the determined one or more properties. The one or more properties may comprise any suitable properties, such as a size and/or format of the encoded (compressed) and/or decoded (decompressed) view of the data array.

The (compression) codec unit could be configured to e.g. always encode or decode (compress or decompress) data in response to a request from the data processing unit. Thus, providing decoded (decompressed) data to the data processing unit may comprise (the manager interface) fetching encoded (compressed) data (e.g. for a compression block) from the memory, (a compression codec) decoding the encoded data, and (the subordinate interface) providing decoded data to the data processing unit. Causing data provided by the data processing unit to be encoded (compressed) may comprise (a compression codec) encoding (compressing) the data, and (the manager interface) storing encoded (compressed) data in the memory.

However, in embodiments, to try to reduce the number of encoding and/or decoding (compression and/or decompression) operations that the codec unit may need to perform, the codec unit comprises local storage that caches data that has been decoded (decompressed) by a compression codec.

In embodiments, the local storage is a block cache that caches compression blocks in decoded (decompressed) form (decoded by a compression codec). In this case, in embodiments, providing decoded data to the data processing unit comprises fetching and decoding (decompressing) data only when it is necessary to do so. Similarly, causing data provided by the data processing unit to be encoded (compressed) may comprise encoding (compressing) and storing the data only when it is necessary to do so.

In particular, in embodiments, in response to a request from the data processing unit to access an address of a set of addresses associated with the codec unit, the codec unit determines whether its local storage is already caching a compression block that corresponds to the address. In embodiments, when it is determined that the local storage is caching a compression block that corresponds to the address, the codec unit provides requested decoded (decompressed) data to the data processing unit by reading the decoded data from the compression block cached in the local storage or causes data provided by the data processing unit to be encoded (compressed) by writing the data to the compression block cached in the local storage.

In embodiments, when it is not determined that the local storage is caching the compression block that corresponds to the address (when it is determined that the local storage is not caching the compression block that corresponds to the address), the (manager interface of the) codec unit fetches the encoded (compressed) compression block (from the memory system), (a compression codec) decodes (decompresses) the encoded compression block, and the decoded (decompressed) compression block is cached in the local storage. Then in embodiments, the codec unit provides requested decoded (decompressed) data to the data processing unit by reading the decoded (decompressed) data from the compression block cached in the local storage or causes data provided by the data processing unit to be encoded (compressed) by writing the data to the compression block cached in the local storage.

In embodiments, a (each) compression block cached in the local storage will be (eventually) evicted, i.e. encoded (by a compression codec) and stored in the memory system in encoded form (by the manager interface). For example, and in embodiments, a compression block cached in the local storage is encoded (compressed) and stored in the memory system in encoded (compressed) form in response to the local storage (cache) being full and/or in response to the data processing unit no longer requiring access to the corresponding encoded data array. Other arrangements are possible.

Another embodiment comprises a method of operating a codec unit that comprises:
a compression codec configured to encode and decode data; and
an interface in communication with a data processing unit;
the method comprising the interface, in response to a request from the data processing unit to access an address of a set of addresses of an address space associated with the (interface of the) codec unit:
   causing the compression codec to encode data provided by the data processing unit or provide decoded data to the data processing unit.

Another embodiment comprises a codec unit comprising:
a compression codec configured to encode and decode data; and
an interface configured to, in response to a request from a data processing unit to access an address of a set of addresses of an address space associated with the (interface of the) codec unit:
   cause the compression codec to encode data provided by the data processing unit or provide decoded data to the data processing unit.

These embodiments can, and in embodiments do, include any one or more or all of the optional features described herein, as appropriate.

The technology described herein can be implemented in any suitable system, such as a suitably operable micro-processor based system. In some embodiments, the technology described herein is implemented in a computer and/or micro-processor based system.

The various functions of the technology described herein can be carried out in any desired and suitable manner. For example, the functions of the technology described herein can be implemented in hardware or software, as desired. Thus, for example, the various functional elements, stages, units, and “means” of the technology described herein may comprise a suitable processor or processors, controller or controllers, functional units, circuitry, circuits, processing logic, microprocessor arrangements, etc., that are operable to perform the various functions, etc., such as appropriately dedicated hardware elements (processing circuits/circuitry) and/or programmable hardware elements (processing circuits/circuitry) that can be programmed to operate in the desired manner.

It should also be noted here that the various functions, etc., of the technology described herein may be duplicated and/or carried out in parallel on a given processor. Equally, the various processing stages may share processing circuits/circuitry, etc., if desired.

Furthermore, any one or more or all of the processing stages or units of the technology described herein may be embodied as processing stage or unit circuits/circuitry, e.g., in the form of one or more fixed-function units (hardware) (processing circuits/circuitry), and/or in the form of programmable processing circuitry that can be programmed to perform the desired operation. Equally, any one or more of the processing stages or units and processing stage or unit circuits/circuitry of the technology described herein may be provided as a separate circuit element to any one or more of the other processing stages or units or processing stage or unit circuits/circuitry, and/or any one or more or all of the processing stages or units and processing stage or unit circuits/circuitry may be at least partially formed of shared processing circuit/circuitry.

It will also be appreciated by those skilled in the art that all of the described embodiments of the technology described herein can include, as appropriate, any one or more or all of the optional features described herein.

The methods in accordance with the technology described herein may be implemented at least partially using software e.g. computer programs. Thus, further embodiments of the technology described herein comprise computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a graphics processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus further embodiments of the technology described herein comprise computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

Embodiments of the technology described herein will now be described with reference to the drawings.

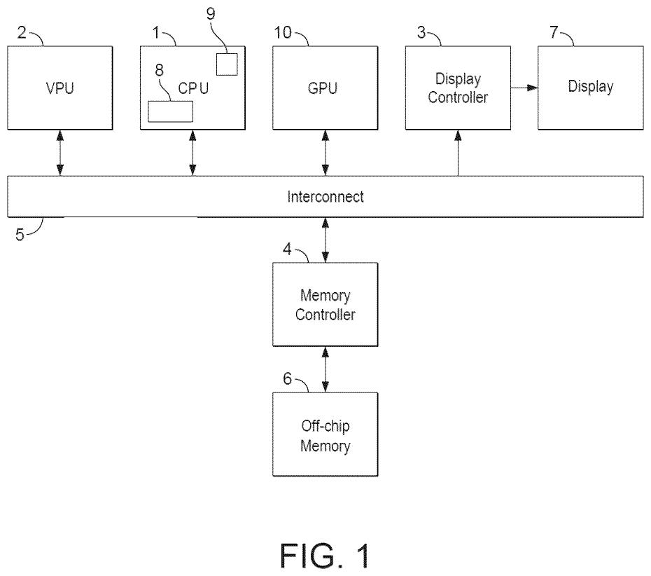

FIG. 1 shows an exemplary data processing system that comprises a host processor comprising a central processing unit (CPU) 1, a graphics processor (graphics processing unit (GPU)) 10, a video processing unit (VPU) 2, and a display controller 3. As shown in FIG. 1, these data processing units can communicate via a bus 5 and have access to an off-chip memory system (memory) 6 via the bus 5 and a memory controller 4. Other processing units may be provided.

In use of this system, the CPU 1, and/or VPU 2 and/or GPU 10 may generate frames (images) to be displayed, and the display controller 3 may provide frames to a display 7 for display. To do this the CPU 1, and/or VPU 2 and/or GPU 10 may read in data from the memory 6 via the interconnect 5, process that data, and return data to the memory 6 via the interconnect 5. The display controller 3 may then read in that data from the memory 6 via the interconnect 5 for display on the display 7.

For example, an application 8, such as a game, executing on the host processor (CPU) 1 may require the display of graphics processing unit rendered frames on the display 7. In this case, the application 8 will send appropriate commands and data to a driver 9 for the graphics processing unit 10 that is executing on the CPU 1. The driver 9 will then generate appropriate commands and data to cause the graphics processing unit 10 to render appropriate frames for display and store those frames in appropriate frame buffers in main memory 6. The display controller 3 will then read those frames into a buffer for the display from where they are then read out and displayed on the display panel of the display 7.

As part of this processing, the graphics processor 10 will read in data, such as textures, geometry to be rendered, etc. from the memory 6, process that data, and then return data to the memory 6 (e.g. in the form of processed textures and/or frames to be displayed), which data will then further, e.g. as discussed above, be read from the memory 6, e.g. by the display controller 3, for display on the display 7.

Thus, there will be a need to transfer data between the memory 6 and processing units (e.g. CPU 1, VPU 2, GPU 10, display controller 3) of the data processing system. In order to facilitate this, and to reduce the amount of data that needs to be transferred to and from memory during processing operations, the data may be stored in a compressed form in the memory 6.

As a processing unit (e.g. CPU 1, VPU 2, GPU 10, display controller 3) will typically need to operate on the data in an uncompressed form, this accordingly means that data that is stored in the memory 6 in compressed form may need to be decompressed before being processed by the processing unit. Correspondingly, data produced by a processing unit (e.g. CPU 1, VPU 2, GPU 10) may need to be compressed before being stored in the memory 6.

Embodiments will now be described that relate to the transfer of image data between the memory system 6 and CPU 1 that is stored in the memory system 6 in a compressed form, but it will be appreciated that other embodiments relate to the transfer of other types of data, and transfer of data between the memory system 6 and other processing units, e.g. GPU 10 etc.

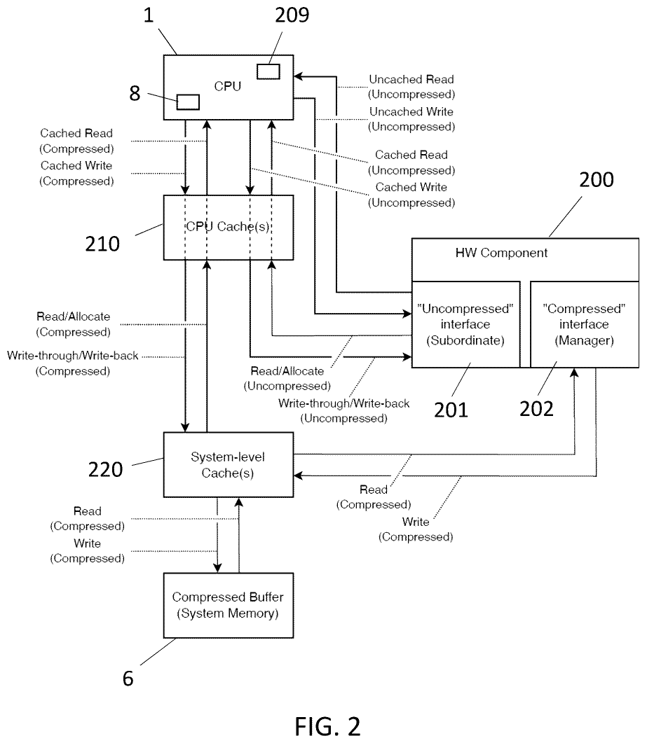

FIG. 2 shows a data processing system in accordance with embodiments of the technology described herein. FIG. 2 shows schematically elements of the data processing system that are relevant to the operation of the present embodiments, and in particular to the transferring of image data between the memory system 6 and CPU 1 in a compressed form. As will be appreciated by those skilled in the art there may be other elements of the system, etc. that are not shown in FIG. 2, e.g. GPU 10 etc.

As shown in FIG. 2, to facilitate compression and decompression of image data that passes between the memory 6 and CPU 1, the data processing system includes a hardware (compression) codec unit 200 that performs the required compression and decompression operations. In the present embodiments, the codec unit 200 is operable to perform block-based encoding (compression), in which a data (e.g. image) array is divided into “blocks” of a particular size, and the blocks are encoded (compressed) individually.

As illustrated in FIG. 2, the codec unit 200 is logically between the CPU 1 and the memory 6, and is operable to decompress compressed data blocks received from the memory system 6 before providing data in a decompressed form for use by the CPU 1, and, conversely, to compress data received from the CPU 1 that is to be written to the memory system 6 prior to writing that data to the memory 6 in compressed form.

The codec unit 200 operates to effectively present a decompressed view of a compressed buffer (compressed image array) in memory 6 to the CPU 1, such that the CPU 1 can access that decompressed view of the compressed buffer as if accessing an uncompressed buffer (image array). Thus, for example, an application 8 running on the CPU 1 may “transparently” access an image array that is stored in a compressed form in memory 6, without needing to know that the image array is stored in a compressed form.

As illustrated in FIG. 2, in the present embodiments the CPU 1 is associated with CPU cache 210, and the memory 6 is associated with system cache 220. The codec unit 200 includes a manager interface 202 that can communicate with the system memory 6 via the system cache 220 to fetch compressed data blocks from memory 6 and write compressed data blocks to memory 6. The codec unit 200 further includes a subordinate interface 201 that can communicate with the CPU 1 directly or via the CPU cache 210.

In the present embodiments, the codec unit 200 is configured by a driver 209 for the codec unit 200 that is executing on the CPU 1. When an application 8 running on CPU 1 requires access to data in a compressed buffer in memory 6, the driver 209 configures the codec unit 200 to present a decompressed view of the compressed buffer to the CPU 1.

To do this, the driver 209 maps an appropriately sized region of CPU 1 address space to the subordinate interface 201 of the codec unit 200. Accesses to this “decompressed view” address space region (port) by the CPU 1 then triggers the codec unit 200 to perform appropriate memory access, compression and decompression operations. Accesses outside of this address space region by the CPU 1 can trigger direct accesses to memory 6, e.g. bypassing the codec unit 200. Thus, the codec unit 200 is “memory-mapped”, such that an application 8 running on CPU 1 can access a compressed buffer in memory 6 transparently, in essentially the same manner as an uncompressed buffer.

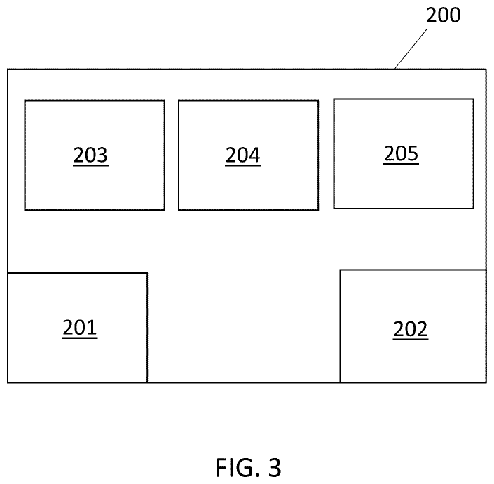

FIG. 3 shows the codec unit 200 in more detail according to embodiments of the technology described herein. FIG. 3 shows schematically elements of the codec unit 200 that are relevant to the operation of the present embodiments. As will be appreciated by those skilled in the art, there may be other elements of the codec unit 200 that are not shown in FIG. 3.

As shown in FIG. 3, the codec unit 200 includes bus subordinate interface 201, bus manager interface 202, local storage 203, compression codec 204, and address converter 205.

In operation, the driver 209 for the codec unit 200 determines appropriate properties of a compressed buffer (image array) in memory 6 that is to be accessed, such as memory addresses for the compressed buffer, a size of the compressed buffer, and a compression block size and other encoding scheme properties for the compressed buffer. Based on the determined properties, the driver 209 configures the compression codec 204 to appropriately compress and decompress data for the compressed buffer.

The driver 209 also determines properties of a decompressed view of the compressed buffer, such as a size of a decompressed image array corresponding to the compressed buffer, and an address space for addressing compression blocks and image elements (e.g. pixels) of the decompressed image array. Based on the determined properties, the driver 209 allocates an appropriately sized “decompressed view” address space region to the subordinate interface 201, and configures the address converter 205 to appropriately convert between these addresses and memory addresses for the compressed buffer (that are used by the manager interface 202).

Then, in response to the subordinate interface 201 receiving a request from the CPU 1 to read data from an address that is within the allocated “decompressed view” address space region, the address converter 205 converts the address to a memory address for the compressed buffer, the manager interface 202 fetches compressed data from the memory address for the compressed buffer, the compression codec 204 decompresses the compressed data, the local storage 203 caches the decompressed data, and the subordinate interface 201 returns decompressed data to the CPU 1.

In response to the subordinate interface 201 receiving a request from the CPU 1 to write uncompressed data to an address that is within the allocated “decompressed view” address space region, the local storage 203 caches the uncompressed data, the compression codec 204 compresses the cached data, the address converter 205 converts the address to a memory address for the compressed buffer, and the manager interface 202 writes compressed data to the memory address for the compressed buffer in the memory 6.

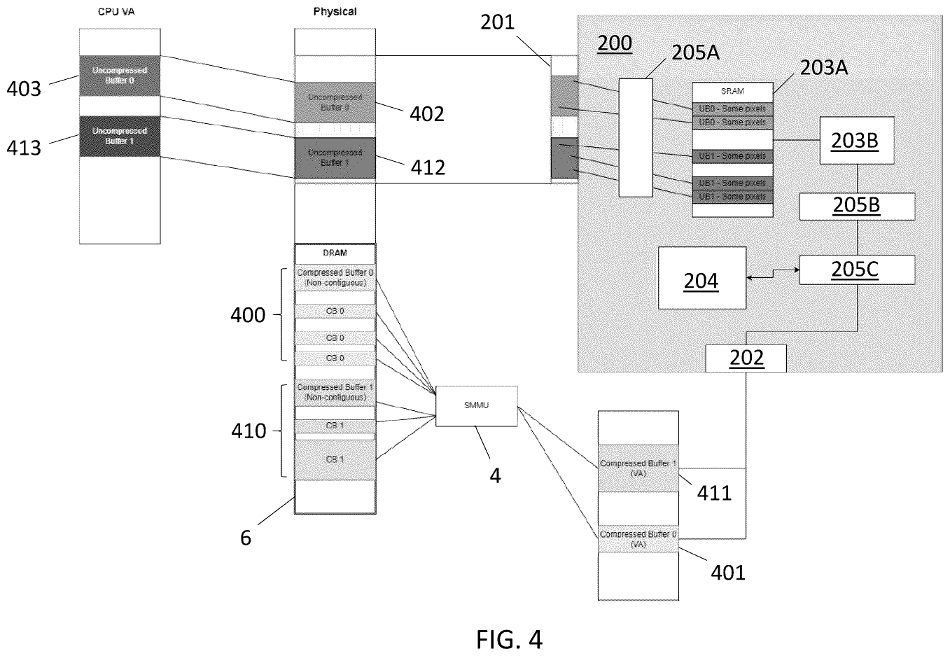

FIG. 4 illustrates in more detail an embodiment in which there are two compressed buffers (image arrays) 400, 410 in memory 6. As illustrated in FIG. 4, the compressed buffers 400, 410 are stored in non-contiguous physical memory addresses, which are mapped to contiguous virtual memory addresses 401, 411 by memory controller 4. Other arrangements are possible. For example, a compressed buffer may be stored in contiguous physical memory addresses.

As shown in FIG. 4, a first “decompressed view” physical address space region 402 is defined to accommodate a decompressed view of the first compressed buffer 400, and is mapped to the subordinate interface 201 (by the driver 209). Similarly, a second “decompressed view” physical address space region 412 is defined to accommodate a decompressed view of the second compressed buffer 410, and is mapped to the subordinate interface 201 (by the driver 209). On account of compression data reduction, a “decompressed view” address space region will typically have more addresses in it than a corresponding “compressed” address space region.

In the present embodiment, as illustrated in FIG. 4, the first and second “decompressed view” physical address space regions 402, 412 are contiguous, and map to corresponding first and second CPU virtual address space regions 403, 413. The first and second “decompressed view” physical address space regions 402, 412 do not overlap the physical addresses at which the corresponding compressed buffers 400, 410 are actually stored. This allows the CPU 1 to both directly access a compressed buffer in memory 6, and access a decompressed view of the compressed buffer (via the codec unit 200).

In the present embodiment, the compression codec 204 is configured to and operable to perform block-based encoding, i.e. in which input image data arrays of a particular “block” size are encoded (compressed) as respective compression blocks. Thus, the compression codec 204 can take as an input a compression block of a particular data size (comprising data arrays of a particular size (W×H)), and compress the compression block to provide an output compressed block of data corresponding to the compression block. Correspondingly, the compression codec 204 can decompress a compressed block of data to provide an output, decompressed block of image data.

As illustrated in FIG. 4, the codec unit 200 has a compression block cache 203A that is operable to cache blocks of data decompressed by the compression codec 204. The compression block cache 203A has a limited capacity, and a control unit 203B handles appropriate allocation and eviction operations for entries of the compression block cache 203A. This operation will be described in more detail below.

As illustrated in FIG. 4, the codec unit 200 then has a first address converter 205A to convert between “decompressed view” physical addresses mapped to the subordinate interface 201 and block entries in the block cache 203A, a second address converter 205B to convert between block entries in the block cache 203A and an array element (e.g. pixel) location within a compression block, and a third address converter 205C to convert between an array element (e.g. pixel) location within a compression block and a (virtual) memory address for the compression block (used by the manager interface 202). Memory management unit (MMU) 4 may convert a virtual memory address used by the manager interface 202 to a physical address in memory 6. Other arrangements are possible.

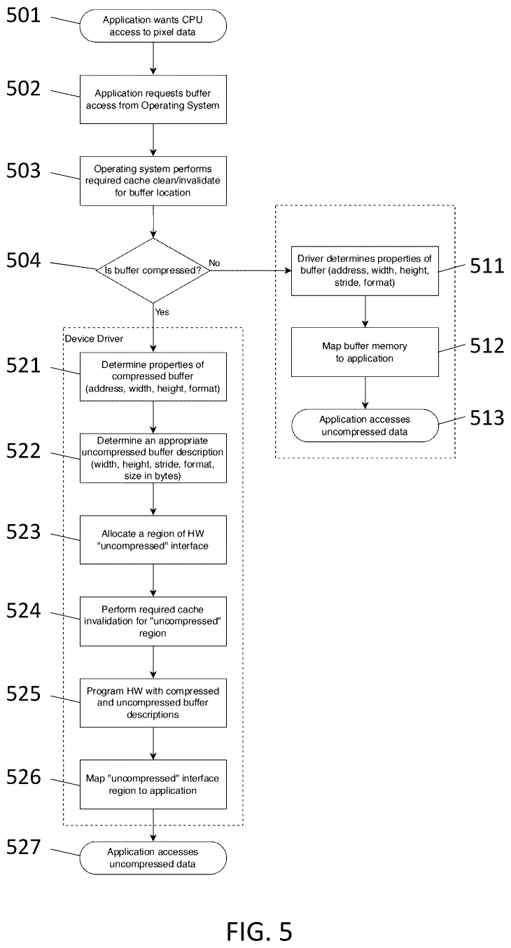

FIGS. 5 to 9 illustrate processes in accordance with embodiments of the technology described herein. As shown in FIG. 5, when an application 8 running on CPU 1 requires access to data stored in a buffer in memory 6 (at step 501), the application 8 requests access to the buffer (at step 502), and cache 210, 220 may be invalidated appropriately (at step 503).

If (at step 504) the buffer is an uncompressed buffer, then appropriate properties of the buffer may be determined (at step 511), and a physical address space range for the buffer may be mapped to a virtual address space range used by the CPU 1 (at step 512), such that the application 8 can then access the uncompressed buffer (at step 513).

On the other hand, if (at step 504) the buffer is a compressed buffer, the driver 209 for the codec unit 200 configures the codec unit 200 to provide a decompressed view of the compressed buffer to the CPU 1 (steps 521-526), such that the application 8 can then access the decompressed view of the compressed buffer (at step 527).

As shown in FIG. 5, to do this, the driver 209 for the codec unit 200 determines (at step 521) properties of the compressed buffer in memory 6, such as physical memory addresses for the compressed buffer, a size of the compressed buffer, and encoding scheme properties for the compressed buffer.

The driver 209 for the codec unit 200 also determines (at step 522) properties of a decompressed view of the compressed buffer, such as a size of the decompressed view, and allocates (at step 523) a “decompressed view” address space region that is large enough to accommodate the decompressed view.

The driver 209 for the codec unit 200 then triggers appropriate cache invalidations for the allocated “decompressed view” address space region (at step 524), configures the codec unit 200 appropriately (at step 525), and maps the “decompressed view” address space region to the CPU 1 (at step 526), e.g. by setting up appropriate page tables.

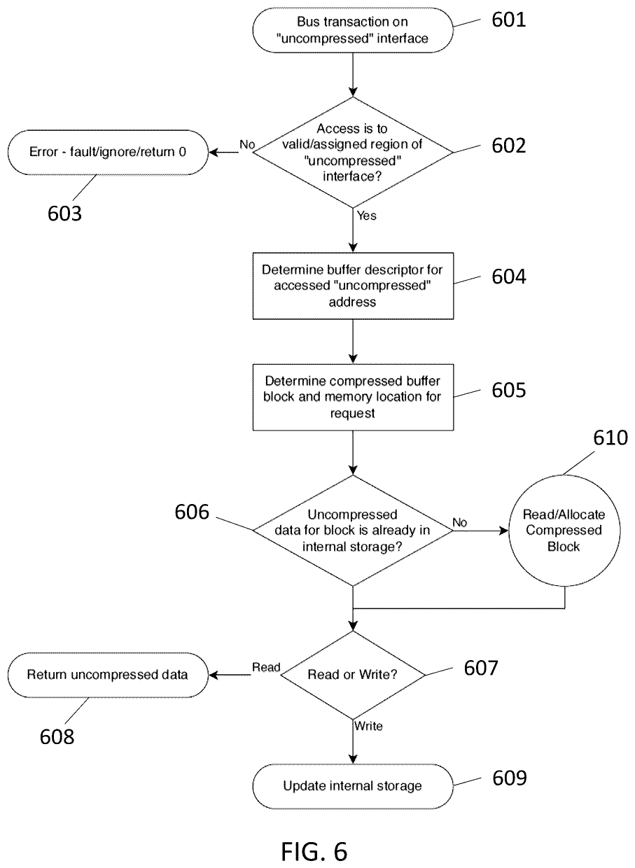

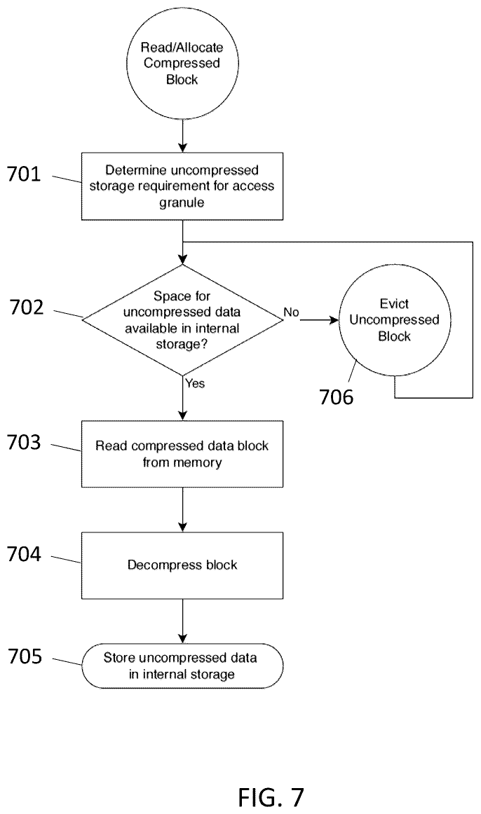

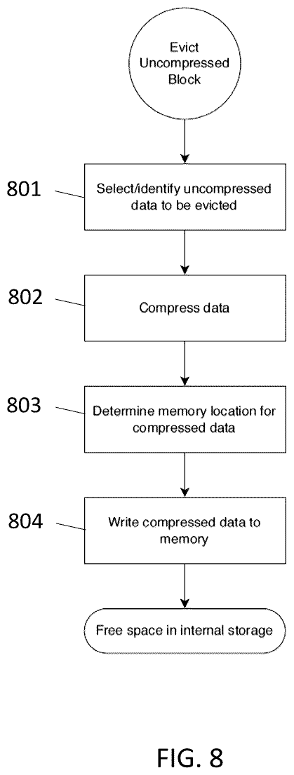

Once the driver 209 for the codec unit 200 has configured the codec unit 200 to provide a decompressed view of the compressed buffer to the CPU 1 (steps 521-526), the application 8 can then access the decompressed view of the compressed buffer (at step 527). This is illustrated in more detail by FIG. 6.

As shown in FIG. 6, when the application 8 wants to access an array element (e.g. pixel) of an image array that is stored as a compressed buffer in memory 6, the CPU 1 issues an access request to an address corresponding to that array element (e.g. pixel) (at step 601). In response to the access request, the codec unit 200 determines whether the address is an address within an address space region that has been mapped to (the subordinate interface 201 of) the codec unit 200 (at step 602). If the address is not within an address space region mapped to the codec unit 200, the codec unit 200 ignores the request (at step 603).

Otherwise, if the address is within an address space region that has been mapped to the codec unit 200, the codec unit 200 identifies (at step 604) the compressed buffer that the address relates to, and determines (at step 605) the compression block within the compressed buffer that the address relates to, and a memory address for that compression block.

The codec unit 200 then uses the determined memory address for the compression block to check whether the required compression block is already present in the block cache 203A (at step 606). If the required compression block is already present in the block cache 203A, and the access request is a read request (at step 607), the codec unit 200 returns the requested array element (e.g. pixel) data from the block cache 203A to the CPU 1 (at step 608). Similarly, if the required compression block is already present in the block cache 203A, and the access request is a write request (at step 607), the codec unit 200 writes array element (e.g. pixel) data to the appropriate location in the block cache 203A (at step 609) (and the updated compression block may then be subsequently compressed and evicted to memory 6 as part of normal cache operation of block cache 203A).

As illustrated in FIG. 6, if (at step 606) the required compression block is not present in the block cache 203A, then the compression block is fetched from memory 6 into the block cache 203A (at step 610). This is illustrated in more detail by FIG. 7.

As shown in FIG. 7, if the codec unit 200 finds that a compression block corresponding to a requested image array element (e.g. pixel) is not present in the block cache 203A, the block cache control unit 203B determines how much storage will be required to store the required compression block in decompressed form in the block cache 203A (at step 701). If (at step 702) there is sufficient space available in the block cache 203A to store the decompressed block, the block cache control unit 203B triggers the manager interface 202 to fetch the compressed block from memory 6 (at step 703), triggers the compression codec 204 to decompress the fetched compressed block (at step 704), and the stores the decompressed data block in the block cache 203A (at step 705).

If, however, there is not sufficient space available in the block cache 203A to store the decompressed block (at step 702), one or more compression blocks are evicted from the block cache 203A to memory 6 by the control unit 203B (at step 706) until there is sufficient space available. FIG. 8 illustrates the block eviction process in more detail.

As shown in FIG. 8, when more space is required in the block cache 203A to store a required compression block, an existing compression block cached in the block cache 203A is identified for eviction (at step 801). Any suitable eviction policy may be used to select a compression block for eviction, such as least recently used (LRU), etc. The selected compression block is then compressed by the compression codec 204 (at step 802), the appropriate memory address to store the compressed block in memory 6 is determined (at step 803), and the compressed block is written to the determined memory address by the manager interface 202 (at step 804).

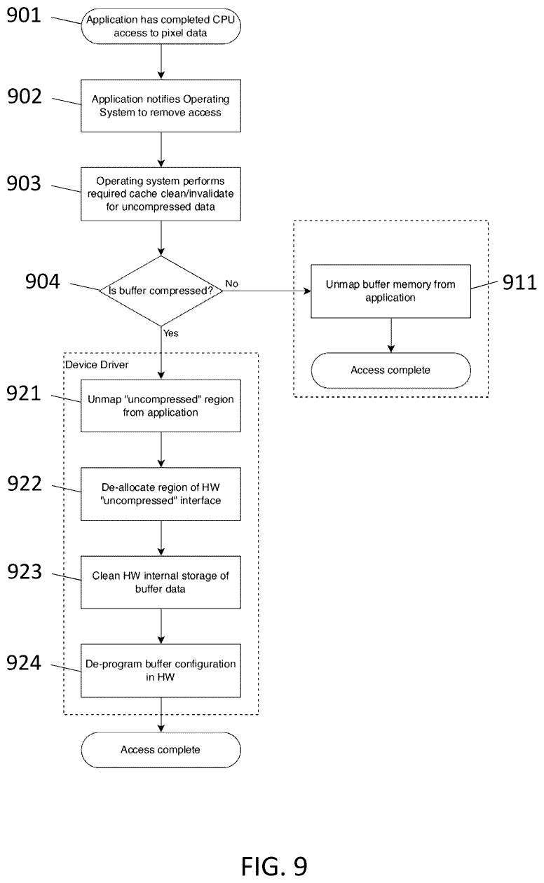

Once the application 8 no longer requires access a buffer, the buffer may be unmapped. This process is shown in FIG. 9.

As shown in FIG. 9, when an application 8 running on CPU 1 no longer requires access to data stored in a buffer in memory 6 (at step 901), the application 8 indicates this (at step 902), and cache 210, 220 may be invalidated appropriately (at step 903). If (at step 904) the buffer is an uncompressed buffer, the buffer address space may be appropriately unmapped (at step 911).

On the other hand, if (at step 904) the buffer is a compressed buffer, the driver 209 for the codec unit 200 deprograms the codec unit 200 appropriately (steps 921-924). As shown in FIG. 9, the driver 209 for the codec unit 200 unmaps a “decompressed view” address space region from the CPU 1 (at step 921), deallocates the “decompressed view” address space region from the subordinate interface 201 (at step 922), compresses and evicts any updated compression blocks stored in the block cache 203A to memory 6 (at step 923), and re-configures the codec unit 200 (at step 924). The codec unit 200 is then ready to be configured to provide a decompressed view of a different compressed buffer to the CPU 1.

The foregoing detailed description has been presented for the purposes of illustration and description. It is not intended to be exhaustive or to limit the technology to the precise form disclosed. Many modifications and variations are possible in the light of the above teaching. The described embodiments were chosen in order to best explain the principles of the technology and its practical application, to thereby enable others skilled in the art to best utilise the technology in various embodiments and with various modifications as are suited to the particular use contemplated. It is intended that the scope be defined by the claims appended hereto.

1. A method of operating a data processing system that comprises:
a data processing unit; and
a codec unit configured to encode and decode data;
the method comprising:
associating a set of addresses of an address space with the codec unit;
determining whether a request is a request from the data processing unit to access an address of the set of addresses associated with the codec unit; and
when it is determined that a request is a request from the data processing unit to access an address of the set of addresses associated with the codec unit, the codec unit responding to the request by:
providing data decoded by the codec unit to the data processing unit; or
causing data provided by the data processing unit to be encoded by the codec unit.

2. The method of claim 1, comprising:
the data processing unit executing a driver for the codec unit; and
the driver for the codec unit associating the set of addresses with the codec unit and configuring the codec unit to respond to requests from the data processing unit to access an address of the set of addresses associated with the codec unit.

3. The method of claim 1, wherein the data processing system comprises a memory system, and the method comprises:
associating a different set of addresses of the same address space with the memory system;
determining whether a request is a request from the data processing unit to access an address of the different set of addresses associated with the memory system; and
when it is determined that a request is a request from the data processing unit to access an address of the different set of addresses associated with the memory system, the memory system responding to the request by:
providing data to the data processing unit; or
storing data provided by the data processing.

4. The method of claim 1, comprising:
associating the set of addresses with the codec unit in response to the data processing unit requiring access to an encoded data array, wherein the set of addresses is configured to address a decoded view of the encoded data array;
wherein the codec unit providing data decoded by the codec unit to the data processing unit comprises the codec unit providing data of the encoded data array to the data processing unit in decoded form; and
wherein the codec unit causing data provided by the data processing unit to be encoded by the codec unit comprises the codec unit causing data provided by the data processing unit to be encoded and stored in the encoded data array in encoded form.

5. The method of claim 4, wherein associating the set of addresses with the codec unit comprises:
determining one or more properties of the data array; and
allocating the set of addresses based on the determined one or more properties of the data array.

6. The method of claim 4, wherein the encoded data array is stored in a memory system, and the method comprises the codec unit responding to the request by:
converting the address of the set of addresses associated with the codec unit to a memory address at which data of the encoded data array is stored in the memory system; and
using the memory address to fetch encoded data of the encoded data array from the memory system, or to write encoded data to the encoded data array stored in the memory system.

7. The method of claim 1, wherein the codec unit is configured to encode and decode compression blocks of data using block-based encoding, and comprises local storage configured to cache one or more compression blocks in decoded form; and
wherein the method comprises the codec unit responding to the request by:
determining whether the local storage is caching a compression block that corresponds to the address;
when it is determined that the local storage is caching a compression block that corresponds to the address:
providing data decoded by the codec unit to the data processing unit by reading the decoded data from the compression block cached in the local storage; or
causing data provided by the data processing unit to be encoded by the codec unit by writing the data to the compression block cached in the local storage; and
when it is not determined that the local storage is caching a compression block that corresponds to the address:
fetching and decoding the compression block;
the local storage caching the compression block in decoded form; and
providing data decoded by the codec unit to the data processing unit by reading the decoded data from the compression block cached in the local storage; or
causing data provided by the data processing unit to be encoded by the codec unit by writing the data to the compression block cached in the local storage.

8. The method of claim 7, comprising in response to the local storage being full, evicting a compression block cached in the local storage by encoding the compression block and storing the compression block in encoded form.

9. A method of operating a data processing system that comprises:
a data processing unit; and
a codec unit configured to encode and decode data;
the method comprising:
associating a set of addresses of an address space with the codec unit; and
configuring the codec unit to:
determine whether a request is a request from the data processing unit to access an address of the set of addresses associated with the codec unit; and
when it is determined that a request is a request from the data processing unit to access an address of the set of addresses associated with the codec unit, respond to the request by:
providing data decoded by the codec unit to the data processing unit; or
causing data provided by the data processing unit to be encoded by the codec unit.

10. A non-transitory computer readable storage medium storing software code which when executing on a processor performs the method of claim 9.

11. A method of operating a codec unit that comprises:
a compression codec circuit configured to encode and decode data; and
an interface in communication with a data processing unit;
the method comprising:
determining whether a request received by the interface is a request from the data processing unit to access an address of a set of addresses of an address space associated with the codec unit; and
when it is determined that a request received by the interface is a request from the data processing unit to access an address of a set of addresses of an address space associated with the codec unit, responding to the request by:
providing data decoded by the compression codec circuit to the data processing unit; or
causing data provided by the data processing unit to be encoded by the compression codec circuit.

12. A data processing system comprising:
a data processing unit; and
a codec unit configured to encode and decode data;
wherein the data processing system is configured to associate a set of addresses of an address space with the codec unit; and
the codec unit is configured to:
determine whether a request is a request from the data processing unit to access an address of the set of addresses associated with the codec unit; and
when it is determined that a request is a request from the data processing unit to access an address of the set of addresses associated with the codec unit, respond to the request by:
providing data decoded by the codec unit to the data processing unit; or
causing data provided by the data processing unit to be encoded by the codec unit.

13. The system of claim 12, wherein:
the data processing unit is configured to execute a driver for the codec unit; and
the driver for the codec unit is configured to associate the set of addresses with the codec unit and configure the codec unit to respond to requests from the data processing unit to access an address of the set of addresses associated with the codec unit.

14. The system of claim 12, comprising a memory system;
wherein the data processing system is configured to associate a different set of addresses of the same address space with the memory system; and
the memory system is configured to:
determine whether a request is a request from the data processing unit to access an address of the different set of addresses associated with the memory system; and
when it is determined that a request is a request from the data processing unit to access an address of the different set of addresses associated with the memory system, respond to the request by:
providing data to the data processing unit; or
storing data provided by the data processing.

15. The system of claim 12, wherein the data processing system is configured to associate the set of addresses with the codec unit in response to the data processing unit requiring access to an encoded data array, wherein the set of addresses is configured to address a decoded view of the encoded data array;
wherein the codec unit is configured to provide data decoded by the codec unit to the data processing unit by providing data of the encoded data array to the data processing unit in decoded form; and
wherein the codec unit is configured to cause data provided by the data processing unit to be encoded by the codec unit by causing data provided by the data processing unit to be encoded and stored in the encoded data array in encoded form.

16. The system of claim 15, wherein the data processing system is configured to associate the set of addresses with the codec unit by:
determining one or more properties of the data array; and
allocating the set of addresses based on the determined one or more properties of the data array.

17. The system of claim 15, wherein the encoded data array is stored in a memory system; and the codec unit is configured to respond to a request from the data processing unit to access an address of the set of addresses associated with the codec unit by:
converting the address of the set of addresses associated with the codec unit to a memory address at which data of the encoded data array is stored in the memory system; and
using the memory address to fetch encoded data of the encoded data array from the memory system, or to write encoded data to the encoded data array stored in the memory system.

18. The system of claim 12, wherein the codec unit is configured to encode and decode compression blocks of data using block-based encoding, and comprises local storage configured to cache one or more compression blocks in decoded form; and
the codec unit is configured to:
respond to a request from the data processing unit to access an address of the set of addresses associated with the codec unit by:
determining whether the local storage is caching a compression block that corresponds to the address;
when it is determined that the local storage is caching the compression block that corresponds to the address:
providing data decoded by the codec unit to the data processing unit by reading the decoded data from the compression block cached in the local storage;
causing data provided by the data processing unit to be encoded by the codec unit by writing the data to the compression block cached in the local storage; and
when it is not determined that the local storage is caching the compression block that corresponds to the address:
fetching and decoding the compression block;
causing the local storage to cache the compression block in decoded form; and
providing data decoded by the codec unit to the data processing unit by reading the decoded data from the compression block cached in the local storage; or
causing data provided by the data processing unit to be encoded by the codec unit by writing the data to the compression block cached in the local storage.

19. The system of claim 18, wherein the codec unit is configured to:
in response to the local storage being full, evict a compression block cached in the local storage by encoding the compression block and storing the compression block in encoded form.

20. A codec unit comprising:
a compression codec circuit configured to encode and decode data; and
an interface for communicating with a data processing unit;
wherein the codec unit is configured to:
determine whether a request received by the interface is a request from the data processing unit to access an address of a set of addresses of an address space associated with the codec unit; and
when it is determined that a request received by the interface is a request from the data processing unit to access an address of a set of addresses of an address space associated with the codec unit:
provide data decoded by the compression codec circuit to the data processing unit; or
cause data provided by the data processing unit to be encoded by the compression codec circuit.
